(19) United States
(12) Patent Application Publication
(10) Pub. No.: US 2007/0081544 A1
(43) Pub. Date: Apr. 12, 2007

(54) Gateway apparatus, server apparatus, and method for address management

(75) Inventors: Junichi Sakai, Tokyo (JP); Hiroshi Konishi, Fukuoka (JP); Akihiro Nawata, Fukuoka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/350,898

(22) Filed: Feb. 10, 2006

Related U.S. Application Data
(63) Continuation-in-part of application No. 11/247,284, filed on Oct. 12, 2005.

(30) Foreign Application Priority Data
Oct. 13, 2005 (JP) 2005-298719

(51) Int. Cl. H04L 12/56; H04L 12/28

(52) U.S. Cl. 370/401

(57) ABSTRACT

A gateway apparatus obtains IPv6 address information assigned to a monitoring camera by using a camera search unit and assigns a host name to the monitoring camera by using a camera information registration unit, the monitoring camera being connected to the gateway apparatus via a network. The gateway apparatus stores the host name and the IPv6 address of the monitoring camera in a camera information database, and stores the host name and the IPv6 address of the monitoring camera on a DDNS server in association with the host name assigned to the gateway apparatus.

### BACKGROUND OF THE INVENTION

1. Field of the Invention

The present invention relates to a gateway apparatus, a server apparatus, and a method for address management, the gateway apparatus and server apparatus being connected to an IP (Internet Protocol) network.

2. Description of Related Art

Internet technologies based on IP networks are becoming widely used. As an example, there are monitoring systems that use monitoring cameras (hereafter referred to as “cameras”) installed in shops and homes to monitor image data of the places through IP networks. For such systems, IPv4 (IP version 4), which is the current standard protocol, is generally used.

In a system that uses IPv4, a global address is only assigned to a gateway apparatus (hereafter referred to as HGW), which controls the cameras, and private addresses are assigned to the cameras. The global address of the HGW is registered on a DNS server. The HGW stores for each camera a private address and a port number corresponding to the private address. When an external PC or the like accesses a camera, a port number (for example, 1000) is added to the URL of the HGW (for example, “http://hgw1.miemasu.net/”) and the resulting URL (for example, “http://hgw1.miemasu.net:1000/”) is specified. The HGW converts the URL to the private address corresponding to the port number and forwards packets to the intended camera.

In recent years, IPv6 (IP version 6) has been proposed as a protocol for overcoming various problems, such as the address exhaustion, associated with IPv4. A network system using IPv6 has been proposed (for example, see Related Art 1). It is conceivable that a monitoring system as described above can be realized by using IPv6. In a monitoring system that uses IPv6, not only a HGW but also cameras are assigned global addresses. By registering the global address of a camera on a DNS server, the camera can be directly accessed from an external PC by specifying the URL of the camera (for example, “http://cam1.hgw1.miemasu.net/”).

[Related Art 1] Japanese Laid Open Publication 2004-56382

However, as described above, in a system that uses IPv6, cameras are also assigned global addresses. Therefore, a user must register the IPv6 addresses of the cameras on a DNS server, causing a problem where such registration process can be cumbersome.

In particular, it is common that a plurality of cameras are installed in a shop or the like in order to achieve a desired security goal. Therefore, when a plurality of cameras are installed, the registration process becomes more cumbersome.

### SUMMARY OF THE INVENTION

The present invention is provided to address the above-described situation. The purpose of the present invention is to provide a gateway apparatus, a server apparatus and a method for address management, that enable easy registration of IPv6 addresses of terminal apparatuses.

The gateway apparatus according to the present invention obtains an IPv6 address assigned to a terminal apparatus, which is connected to the gateway apparatus via a network, and assigns a host name to the terminal apparatus. The gateway apparatus stores the host name and the IPv6 address information of the terminal apparatus in a memory, and further stores the host name and IPv6 address information of the terminal apparatus on a DNS server in association with a host name assigned to the gateway apparatus itself, the host name and IPv6 address of the terminal apparatus being in the memory of the gateway apparatus.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 shows a network configuration to which a gateway apparatus (HGW) according to a first embodiment of the present invention is applied;

FIG. 2 is a block diagram describing a configuration of the gateway apparatus according to the first embodiment;

FIG. 3 shows an example of camera information stored in the camera information DB of the gateway apparatus according to the first embodiment;

FIG. 4 shows an example of a server registration packet generated by the HGW information registration unit of the gateway apparatus according to the first embodiment;

FIG. 5 shows an example of HGW information stored in the server DB of the DDNS server according to the first embodiment;

FIG. 6 is a sequence diagram describing operations performed until image data of the first camera in a home is checked from a PC in the monitoring system to which the gateway apparatus according to the first embodiment is applied;

FIG. 7 is a flow chart describing the operation (the automatic registration operation) of automatically registering in the camera information DB the camera information for the cameras controlled by the gateway apparatus according to the first embodiment;

FIG. 8 is a flow chart describing the operation (the manual registration operation) of manually registering in the camera information DB the camera information for the cameras controlled by the gateway apparatus according to the first embodiment;

FIG. 9 is a flow chart describing the operation (the server registration operation) of registering the HGW information on the DDNS server in the gateway apparatus according to the first embodiment;

FIG. 10 is a flow chart describing the operation (the HGW information registration operation) of registering the HGW information including the information about the cameras controlled by the gateway apparatus on the DDNS server according to the first embodiment.

FIG. 11 is a block diagram describing a configuration of a gateway apparatus (HGW) according to a second embodiment of the present invention;

FIG. 12 shows an example of the server registration packet transmitted by the HGW according to the second embodiment;

FIG. 13 shows an example of the HGW information stored in the server DB of the DDNS server according to the second embodiment;

FIG. 14 shows an example of a response packet transmitted by the DDNS server according to the second embodiment;

FIG. 15 is a sequence diagram describing operations performed until image data of the first camera in a home is checked from a PC in the monitoring system, to which the gateway apparatus according to the second embodiment is applied;

FIG. 16 is a flow chart describing the operation (the server registration operation) of registering HGW information on DDNS server in the gateway apparatus according to the second embodiment; and

FIG. 17 is a flow chart describing the operation (the HGW information registration operation) of registering HGW information on the DDNS server according to the second embodiment.

### DETAILED DESCRIPTION OF PREFERRED EMBODIMENTS

The embodiments of the present invention are explained in detail in the following in reference to the above-described drawings.

### First Embodiment

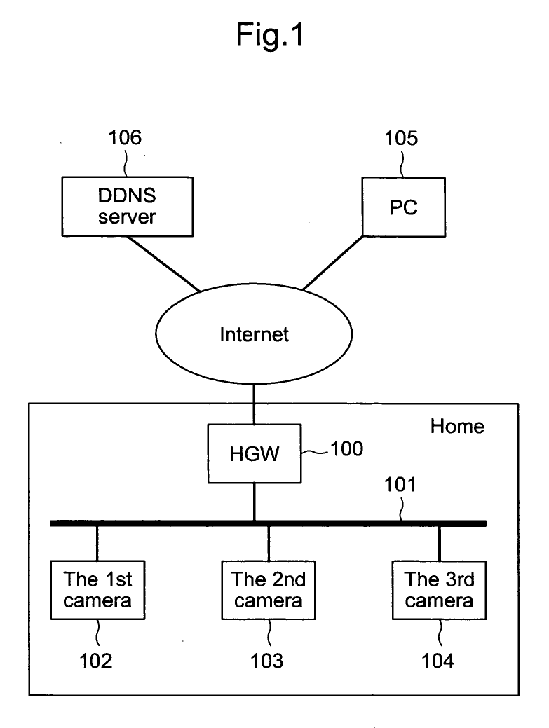

FIG. 1 shows a network configuration of a monitoring system to which a gateway apparatus according to a first embodiment of the present invention is applied. In the following, a case is explained in which gateway apparatus (hereafter referred to as “HGW: Home Gateway”) 100 is installed in a home and is used to control monitoring cameras (hereafter referred to simply as “cameras”).

In the monitoring system shown in FIG. 1, HGW 100 installed in a home is connected to the Internet. HGW 100 is connected, for example, via LAN 101 installed in the home, to a plurality of cameras: the first camera 102—the third camera 104. HGW 100 manages the information related to these cameras (hereafter referred to as “camera information”). HGW 100 is compatible with both IPv4 and IPv6. For example, HGW 100 manages camera information that includes both IPv4 and IPv6 addresses assigned to the cameras. The first camera 102—the third camera 104 are installed respectively in different rooms or hallways or the like and monitor intruders or the like entering the home.

Further, HGW 100 has a function as a web server and provides a homepage to PC 105 which accesses HGW 100 via the Internet. HGW 100 makes a portal screen on the homepage, the portal screen showing together the image data taken by the cameras controlled by HGW 100. DDNS server 106 stores a dynamic IP address of HGW 100 in association with the host name (for example, hgw1) of HGW 100. Upon receiving from PC 105 a request specifying the host name of HGW 100, DDNS server 106 notifies PC 105 of the IP address of HGW 100 in response to the request. PC 105 accesses HGW 100 by using the notified IPv6 address. Thus, it is possible for PC 105 to access HGW 100 by specifying only the host name of HGW 100. In the first embodiment, it is assumed that it is possible for PC 105 to access HGW 100 by specifying “http://hgw1.miemasu.net/” as a URL. Here hgw1 is the host name of HGW 100, and miemasu.net is the domain name controlled by DDNS server 106.

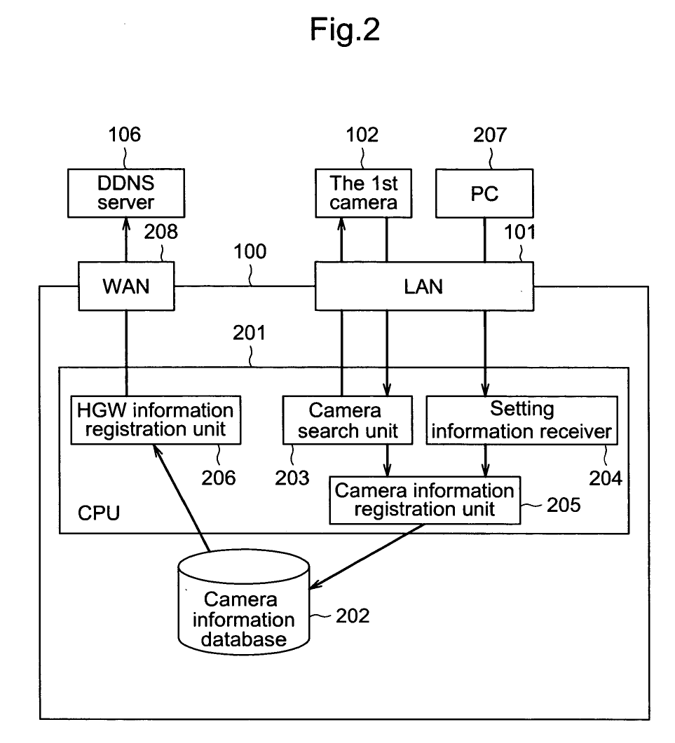

FIG. 2 is a block diagram describing a configuration of the gateway apparatus (HGW 100) according to the first embodiment. In FIG. 2, only the first camera 102 is shown as the cameras connected to HGW 100.

As FIG. 2 shows, HGW 100 includes CPU 201 and camera information database (hereafter referred to as “camera information DB”) 202. CPU 201 controls the operation of the entire gateway apparatus. CPU 201 has functions of camera search unit 203, setting information receiver 204, camera information registration unit 205, and HGW information registration unit 206.

Camera search unit 203 functions as an address obtaining unit and searches the first camera 102 on LAN 101. When the first camera 102 is found, camera search unit 203 requests for an identification number of the camera (hereafter referred to as “camera ID number”) and an IPv6 address and the like (IPv6 address and IPv6 port number) of the camera, and obtains the camera ID number and the IPv6 address of the camera, the IPv6 address and the like (IPv6 address and IPv6 port number) of the camera being assigned to the camera when the camera is connected to a network.

Setting information receiver 204 functions as a receiver and receives the information (setting information) specified by a user from a terminal such as PC 207 that is connected via LAN 101 to HGW 100. For example, setting information receiver 204 receives from PC 207 a host name and an IP address and the like (IPv6 address and IPv6 port number and IPv4 address and IPv4 port number) of a camera newly connected to LAN 101. The information about the camera ID number, the IPv6 address and the like obtained by camera search unit 203 and the information about the host name, the IP address and the like obtained by setting information receiver 204 are forwarded to camera information registration unit 205.

Camera information registration unit 205 functions as a host naming unit, and stores the information received from camera search unit 203 or setting information receiver 204 as camera information in camera information DB 202. When doing so, camera information registration unit 205 assigns a host name for information that does not contain a host name and then stores the information in camera information DB 202. Specifically, since a host name is not assigned in the information received from camera search unit 203, camera information registration unit 205 assigns a host name for the information received from camera search unit 203 and then stores the information in camera information DB 202. Further, for information that does not contain an IPv4 address and the like (IPv4 address and IPv4 port number), camera information registration unit 205 assigns an IPv4 address and the like for the information and then stores the information in camera information DB 202. Therefore, since a host name as well as an IPv4 address and the like are assigned by camera information registration unit 205, it is possible to accommodate even the case where a terminal such as PC 105 uses IPv4 to check the image data of the cameras.

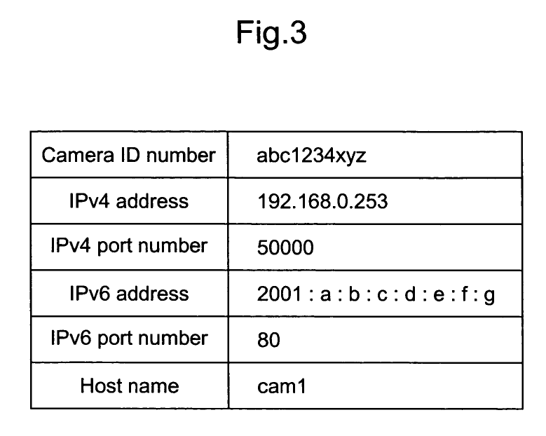

FIG. 3 shows an example of the camera information stored in camera information DB 202 of the gateway apparatus (HGW 100) according to the first embodiment. FIG. 3 shows a single camera information (camera ID number “abc123xyz”) stored in camera information DB 202.

As FIG. 3 shows, camera information DB 202 stores camera information corresponding to each camera. Camera information includes a camera ID number, an IPv4 address, an IPv4 port number, an IPv6 address, an IPv6 port number, and a host name for each camera.

An IPv4 address and an IPv4 port number are used in the case where a terminal such as PC 105 uses IPv4 to check the image data of the first camera 102, and an IPv6 address and an IPv6 port number are used in the case where a terminal such as PC 105 uses IPv6 to check the image data of the first camera 102. In particular, the IPv4 port number is used when the global IP address of HGW 100 is translated to the private IP address of the first camera 102.

When camera search unit 203 performs a camera search, a camera ID number, an IPv4 address, an IPv4 port number, an IPv6 address, an IPv6 port number, and a host name as shown in FIG. 3 are stored in camera information DB 202 as camera information for each camera. On the other hand, when setting information receiver 204 receives setting information, an IPv4 address, an IPv4 port number, an IPv6 address, an IPv6 port number, and a host name as shown in FIG. 3 are stored in camera information DB 202 as camera information for each camera.

HGW information registration unit 206 stores in DDNS server 106 the information about HGW 100 (hereafter referred to as “HGW information”), which excludes the host name of HGW 100. Specifically, HGW information registration unit 206 generates a packet (hereafter referred to as a “server registration packet”) containing the IP address of HGW 100 and the like and the information about the cameras controlled by HGW 100, and, by transmitting the server registration packet to DDNS server 106 via WAN 208, stores the HGW information in DDNS server 106.

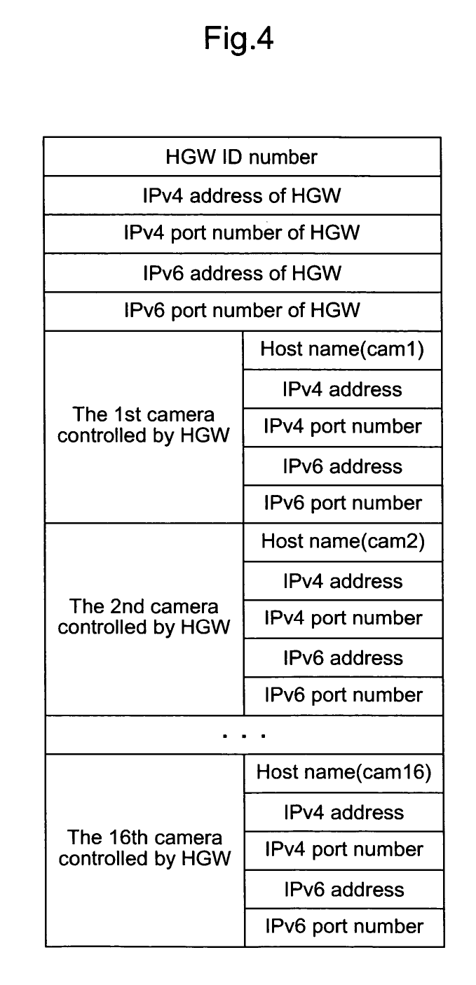

FIG. 4 shows an example of a server registration packet generated by HGW information registration unit 206 of the gateway apparatus (HGW 100) according to the first embodiment. FIG. 4 shows a case where 16 cameras (the 1st camera-the 16th camera) are controlled by HGW 100. A host name is assigned to each of the 16 cameras such as “cam1” for the first camera, “cam2” for the second camera, etc.

As FIG. 4 shows, the server registration packet contains an identification number (hereafter referred to as “HGW ID number”), an IPv4 address, an IPv4 port number, an IPv6 address and an IPv6 port number of HGW 100. Further, the server registration packet contains camera information, excluding camera ID number, for every camera controlled by HGW 100. FIG. 4 shows an example where the server registration packet contains camera information, excluding camera ID numbers, for all of the 1st camera-the 16th camera.

The HGW ID number is used by DDNS server 106 to identify HGW 100. The IPv4 address and the IPv4 port number are used by a terminal such as PC 105 to view homepages of HGW 100 according to IPv4; and the IPv6 address and the IPv6 port number are used to view homepages of HGW 100 according to IPv6.

Based on the server registration packet received from HGW information registration unit 206, DDNS server 106 stores HGW information in the server database (hereafter referred to as “server DB”), which is not shown in the figures. Specifically, HGW information is obtained from the server registration packet by removing the HGW ID number in the server registration packet and assigning a host name for HGW 100; the HGW information so obtained is stored in the server DB.

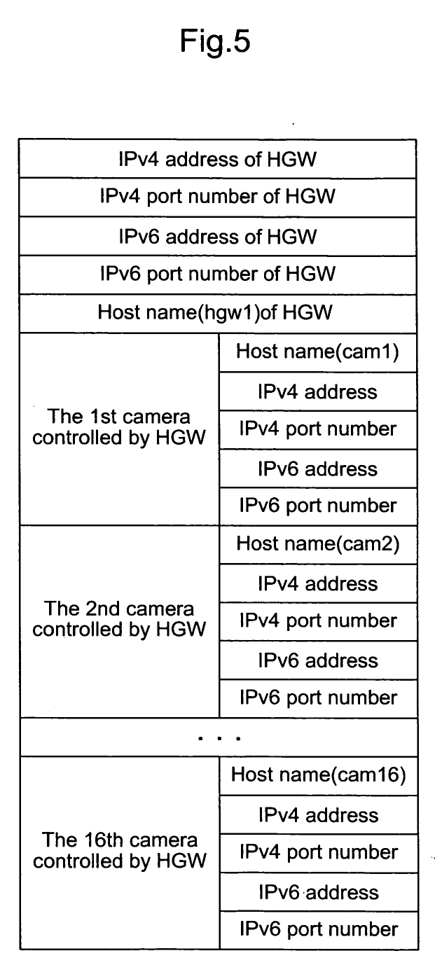

FIG. 5 shows an example of HGW information stored in the server DB of DDNS server 106 according to the first embodiment. FIG. 5 shows the case where the stored HGW information is obtained from the information contained in the server registration packet shown in FIG. 4.

As FIG. 5 shows, the HGW information stored in the server DB is different from the information contained in the server registration packet shown in FIG. 4 in that the HGW ID number is removed and a host name for HGW 100 (“hgw1” in FIG. 5) is added. Except this difference, other data contained in the HGW information are the same as those in the server registration packet shown in FIG. 4, and their descriptions are thus omitted.

The following describes the operations that are performed until the image data of the first camera 102 in the home is checked from PC 105 in the monitoring system to which HGW 100 according to the first embodiment is applied.

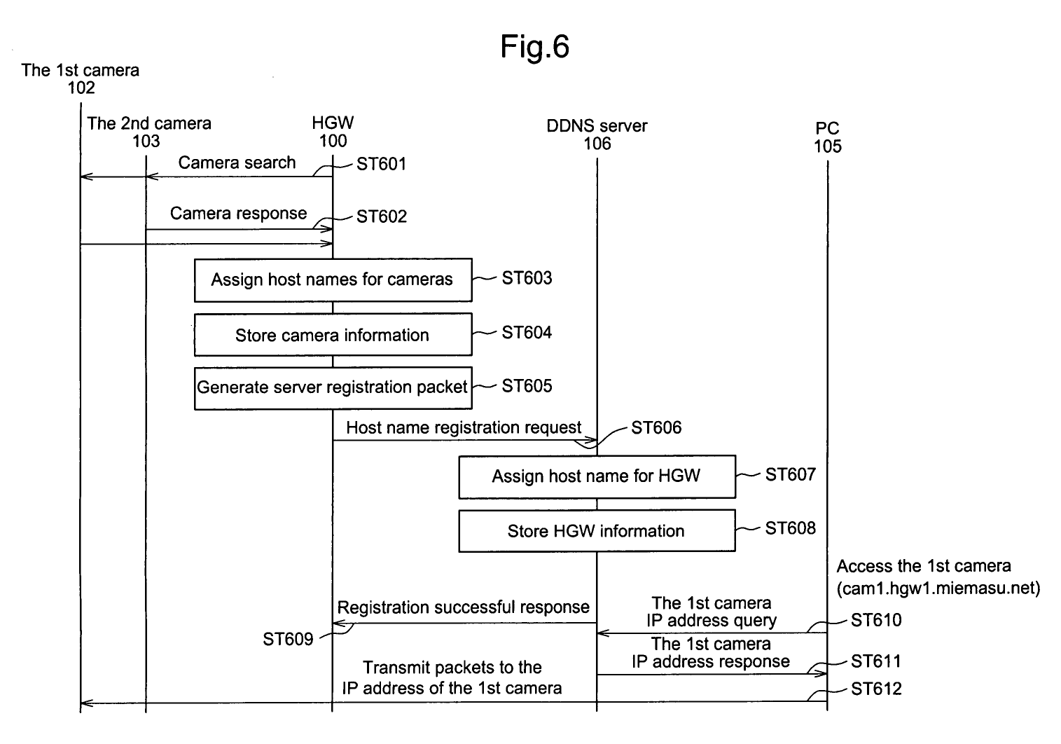

FIG. 6 shows a sequence diagram describing the operations performed until the image data of the first camera 102 in the home is checked from PC 105 in the monitoring system to which HGW 100 according to the first embodiment is applied. FIG. 6 shows the case where the first camera 102 and the second camera 103 are installed in the home. The first camera 102 and the second camera 103 are each assigned an IPv6 address and an IPv6 port number when connected to a network. Further, FIG. 6 shows the case where a camera search is performed by camera search unit 203 of HGW 100.

By booting up HGW 100 installed in the home, the sequence of operations shown in FIG. 6 is started. When booted up, HGW 100 performs a search (camera search) for cameras (the first camera 102 and the second camera 103) installed in the home (ST 601). When camera search is performed, HGW 100 receives a response (camera response), which contains a camera ID, an IPv6 address, and the like, from each of the cameras connected to the network (ST 602).

Upon receiving camera responses from all cameras, HGW 100 assigns a host name for each of the cameras (ST 603). When assigning a host name, HGW 100 assigns as necessary an IPv4 address and the like as well for each of the cameras. Then, HGW 100 stores in camera information DB 202 the information including host names and the like as camera information (ST 604). For example, as camera information for the first camera 102, the camera information shown in FIG. 3 is stored in camera information DB 202. As FIG. 3 shows, “cam1” is stored as the host name for the first camera 102.

After camera information for all cameras are stored in camera information DB 202, HGW 100 generates a server registration packet (ST 605). When the server registration packet is generated, HGW 100 obtains camera information for all cameras stored in camera information DB 202, and combines the camera information to generate a server registration packet.

Upon generating the server registration packet, HGW 100 transmits a request to DDNS server 106 for registering a host name for HGW 100 (ST 606). Specifically, by transmitting the generated server registration packet to DDNS server 106, HGW 100 requests the registration of a host name for HGW 100.

Upon receiving the request for the registration of a host name, DDNS server 106 assigns a host name to HGW 100 (ST 607). Then, DDNS server 106 stores in the server DB as the HGW information the host name, IP address, and the like for HGW 100, as well as the host names, IP addresses, and the like for the cameras controlled by HGW 100 (ST 608). For example, the HGW information shown in FIG. 5 is stored in the server DB as the HGW information for HGW 100. As FIG. 5 shows, “hgw1” is stored as the host name for HGW 100.

After the HGW information is stored in the server DB, DDNS server 106 transmits to HGW 100 a response indicating the registration was successful (registration successful response) (ST 609). By receiving the registration successful response, HGW 100 becomes aware of that the HGW information including the host name for HGW 100 has been stored in the server DB of DDNS server 106.

Here, in order to check the image data of the first camera 102, a user of PC 105 uses a browser function to access the first camera 102. When doing so, the user of PC 105 access the first camera 102 by specifying the host name (cam1) of the first camera 102 and the host name (hgw1) of HGW 100. Specifically, the user of PC 105 specifies “http://cam1.hgw1.miemasu.net” in the browser.

When the user specifies “http://cam1.hgw1.miemasu.net/” in the browser, PC 105 transmits to DDNS server 106 a query regarding the IPv6 address of the first camera 102 (ST 610). In response to the query, DDNS server 106 transmits to PC 105 the IPv6 address of the first camera 102 (ST 611).

Upon receiving the IPv6 address of the first camera 102, PC 105 transmits to the IPv6 address a packet according to the HTTP protocol (ST 612). Thereafter, it becomes possible to check the image data of the first camera 102 on a display of PC 105 or the like.

The following describes the operations performed by HGW 100 and DDNS server 106 in the monitoring system according to the first embodiment.

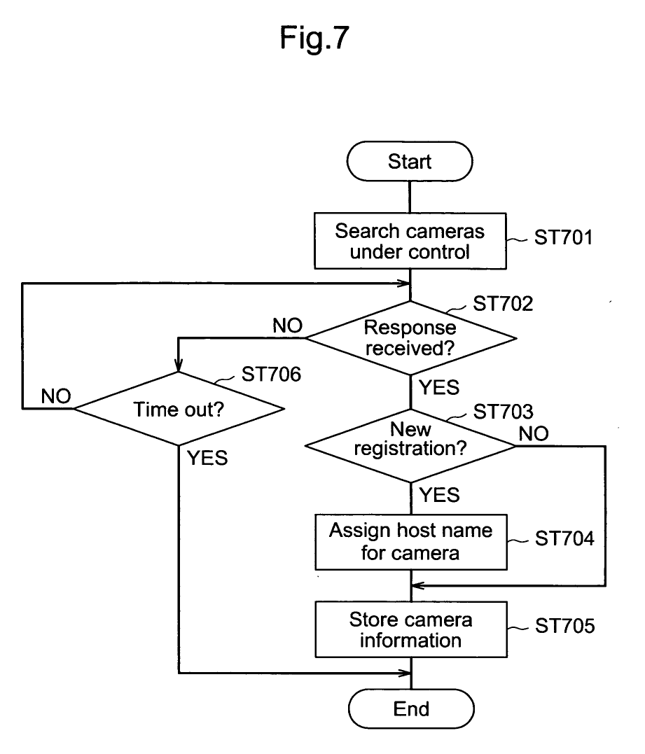

FIG. 7 is a flow chart describing the operation (the automatic registration operation) of automatically registering in camera information DB 202 the camera information for the cameras controlled by HGW 100 according to the first embodiment.

After being booted up by a user, HGW 100 repeats an automatic registration operation shown in FIG. 7 every predetermined interval of time (every 30 seconds, for example) during a predetermined period of time (5 minutes, for example).

When executing the automatic registration operation for camera information, HGW 100 first searches cameras installed in the home by using camera search unit 203 (ST 701). Then, HGW 100 monitors the reception of responses from the cameras, each response containing a camera ID number, an IPv6 address and the like (ST 702).

When a response arrives from a camera, HGW 100 determines by using camera information registration unit 205 whether the camera information for the camera, from which the response was received, is for a new registration (ST 703). Specifically, by determining whether the camera ID number of the camera, from which the response was received, has already been stored in camera information DB 202, HGW 100 determines whether the camera information for the camera is for a new registration.

When the camera ID number of the camera, from which the response was received, does not exist, the camera information for the camera is determined as for a new registration and a host name is assigned to the camera (ST 704). In doing so, HGW 100 uses camera information DB 202 as a reference to avoid duplicate host names. In assigning a host name to a camera, HGW 100 assigns as necessary an IPv4 address and the like to the camera. And then, as the camera information, HGW 100 stores in camera information DB 202 the information including a host name and the like in addition to a camera ID number and the like for each camera, from which a response was received (ST 705).

On the other hand, when the camera ID number of the camera, from which a response was received, has already been stored, HGW 100 determines that a host name has already been assigned to the camera and skips the process of assigning a host name to the camera, and stores directly the information contained in the response as the camera information in camera information DB 202 (ST 705).

When the camera information registration has been completed, HGW 100 terminates the automatic registration operation for the camera information. Thereafter, when the predetermined interval of time passed again, the automatic registration operation is performed in the way described above. By repeating such automatic registration operation for camera information, camera information including host names for all cameras installed in the home is stored in camera information DB 202.

On the other hand, when no response is received from the cameras in ST 702, HGW 100 waits for a predetermined interval of time (ST 706) and terminates the automatic registration operation when the predetermined interval of time passed (timeout). Until the predetermined interval of time has passed, HGW 100 continues monitoring the reception of responses from the cameras.

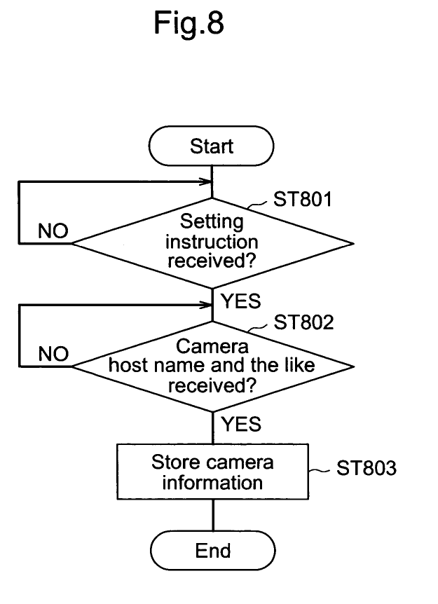

FIG. 8 is a flow chart describing the operation (the manual registration operation) of manually registering in camera information DB 202 the camera information for the cameras controlled by HGW 100 according to the first embodiment.

HGW 100 performs a manual registration operation shown in FIG. 8 for camera information according to an instruction received from a terminal such as PC 105 on the network.

When executing the manual registration operation for camera information, HGW 100 first monitors the reception of a setting instruction from a user using setting information receiver 204 (ST 801), and continues such monitoring until a setting instruction is received from the user.

Upon receiving a setting instruction from a user, HGW 100 monitors this time whether information such as a host name and an IP address of a camera has been received (ST 802), and continues such monitoring until information such as a host name and an IP address of a camera has been received.

When information such as a host name and an IP address of a camera is received, HGW 100 stores the received information such as a host name and an IP address as the camera information in camera information DB 202 by using camera information registration unit 205 (ST 803). Thereafter, HGW 100 terminates the manual registration operation for camera information. By performing such manual registration operation for camera information, camera information of a camera or the like newly connected to LAN 101 is stored in camera information DB 202.

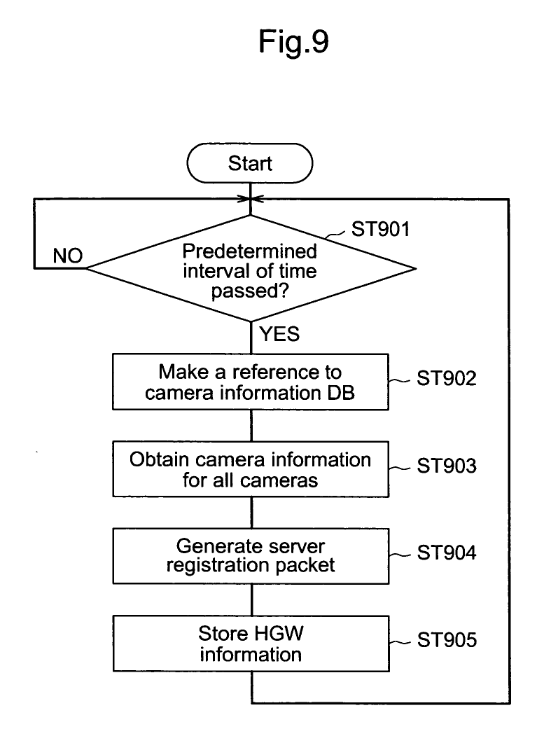

FIG. 9 is a flow chart describing the operation (the server registration operation) of registering HGW information on DDNS server 106, in HGW 100 according to the first embodiment.

When in operation, HGW 100 constantly repeats a server registration operation shown in FIG. 9 every predetermined interval of time (30 seconds, for example).

When executing the server registration operation, HGW 100 first monitors whether a predetermined interval of time has passed (ST 901). When it is confirmed that the predetermined interval of time has passed, HGW 100 makes a reference to the camera information stored in camera information DB 202 by using HGW information registration unit 206 (ST 902).

HGW information registration unit 206 obtains sequentially the camera information for the cameras controlled by HGW 100 (ST 903) and generates a server registration packet containing the obtained camera information for all cameras (ST 904). The server registration packet includes, for example, an ID number and an IP address of HGW 100. The generated server registration packet is transmitted to DDNS server 106 and is stored as HGW information in the server DB (ST 905). When the transmission of the server registration packet is completed, HGW 100 terminates the server registration operation.

Thereafter, when the predetermined interval of time passed again, the server registration operation is performed in the way described above. By repeating such server registration operation for HGW information, HGW information including camera information for the cameras controlled by HGW 100 is stored in the server DB.

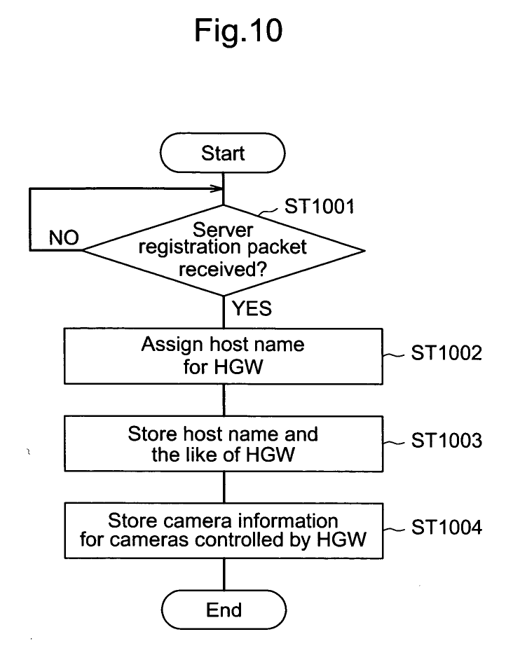

FIG. 10 is a flow chart describing the operation (the HGW information registration operation) of registering HGW information including camera information for the cameras controlled by HGW 100 in DDNS server 106 according to the first embodiment.

When executing the HGW information registration operation, DDNS server 106 monitors the reception of a server registration packet from HGW 100 (ST 1001), and continues such monitoring until the server registration packet from HGW 100 is received.

When the server registration packet is received, DDNS server 106 assigns a host name to HGW 100 (ST 1002). In assigning a host name to HGW 100, DDNS server 106 uses the server DB as a reference to avoid duplicate host names. Then, DDNS server stores the host name and the IP addresses of HGW and the like contained in the server registration packet in the server DB as part of HGW information (ST 1003).

After storing the host name and the like of HGW 100, DDNS server 106 stores the camera information for the cameras controlled by HGW 100 in the server DB as part of the HGW information (ST 1004). When storing the camera information for the cameras controlled by HGW 100 is completed, DDNS server 106 terminates the HGW information registration operation.

Thereafter, when the predetermined interval of time passed again, the HGW information registration operation is performed in the way described above. By repeating such HGW information registration operation, HGW information including a host name for HGW 100 installed in the home and camera information for the cameras controlled by HGW 100 is stored in the server DB.

As described above, according to HGW 100 of the first embodiment, an IPv6 address of a camera obtained by camera search unit 203 and a host name assigned to the camera by camera information registration unit 205 are stored in camera information DB 202, as shown in FIG. 7 and FIG. 8. The host name and IPv6 address of the camera stored in camera information DB 202 are stored in DDNS server 106 in association with a host name assigned to HGW 100 by HGW information registration unit 206, as shown in FIG. 9. Specifically, the host name and IPv6 address of the camera are stored in association with the host name “hgw1.miemasu.net” assigned to HGW 100. Since a host name and an IPv6 address of a camera are automatically stored in DDNS server 106, it is possible to have a monitoring system by using IPv6 without the need of registering an IP address assigned to a camera.

Since a host name and an IPv6 address of a terminal apparatus are stored in a DNS server, it is possible for an external terminal to check image data obtained by an intended terminal apparatus by only recognizing and specifying the host name of the intended terminal apparatus.

In particular, according to HGW 100 of the first embodiment, host names and IPv6 addresses of a plurality of cameras are stored in camera information DB 202. The host names and IPv6 addresses of the plurality of cameras are collectively stored in association with a host name assigned to HGW 100 in DDNS server 106 by HGW information registration unit 206. Since host names and IPv6 addresses of a plurality of cameras are collectively stored in association with a host name assigned to HGW 100 in DDNS server 106, it is possible to store in DDNS server 106 for each HGW the camera information for cameras controlled by the HGW.

Further, according to HGW 100 of the first embodiment, as FIG. 8 shows, setting information receiver 204 of HGW 100 receives a host name and an IPv6 address of a camera specified from a terminal such as PC 207, PC 207 being connected to HGW 100 via a network. The received host name and IPv6 address of the camera are stored in camera information DB 202 by setting information receiver 204, and are stored in association with a host name assigned to HGW 100 on DDNS server by HGW information registration unit 206. Therefore, for example, even in the case where a camera is newly connected to the network, it is possible to register camera information for the newly connected camera according to user instructions input from a terminal such as PC 207, PC 207 being connected to HGW 100 via the network.

Further, according to DDNS server 106 of the first embodiment, as FIG. 10 shows, since host names and the like of the cameras controlled by HGW 100 and an IPv6 address and a host name of HGW 100 are automatically stored in the server DB of DDNS server 106, it is possible to have a monitoring system by using IPv6 without the need of registering IP addresses assigned to the cameras.

The first embodiment has been explained by using a monitoring system to which HGW 100 is applied. However, the present invention is not limited to this case. It is possible to apply the present invention to any system in which an automatic assignment of an IPv6 address is desirable. When HGW 100 of the first embodiment is applied to other systems, it is possible to reduce the burden associated with registering IPv6 addresses in the systems.

### Second Embodiment

The following describes a monitoring system to which a gateway apparatus according to a second embodiment is applied. In the first embodiment, DDNS server 106 manages the correspondences between the host names and the IP addresses of HGW 100 and cameras 102, 103 and 104. In the second embodiment, DDNS server 106 manages the correspondence between the host name and the IP address of HGW 100, and HGW 100 manages the correspondences of the host names and the IP addresses of cameras 102, 103 and 104.

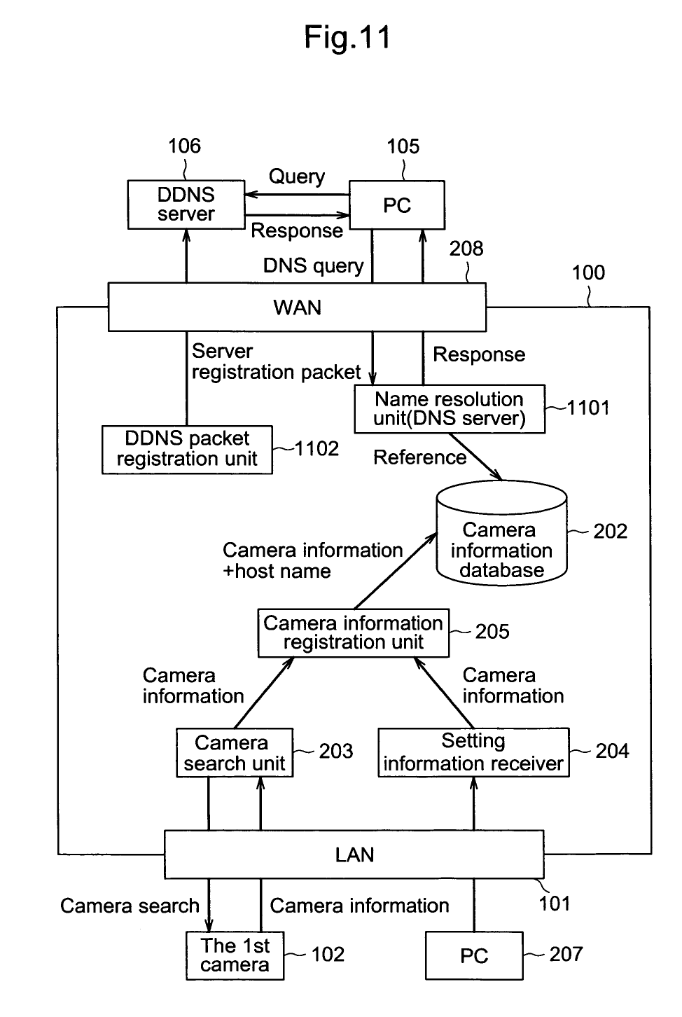

The gateway apparatus according to the second embodiment is also applicable to the monitoring system shown in FIG. 1. FIG. 11 is a block diagram describing a configuration of the gateway apparatus (HGW 100) according to the second embodiment. Elements that are the same as in FIG. 2 are assigned the same symbols and their explanations are thus omitted.

Name resolution unit 1101 functions as a DNS server, and stores all camera information stored in camera information DB 202. Upon receiving from external PC 105 a query regarding the IP address of camera 102, name resolution unit 1101 transmits to PC 105 the IP address of camera 102.

DDNS packet registration unit 1102 stores HGW information on DDNS server 106 by generating and transmitting a server registration packet to DDNS server 106.

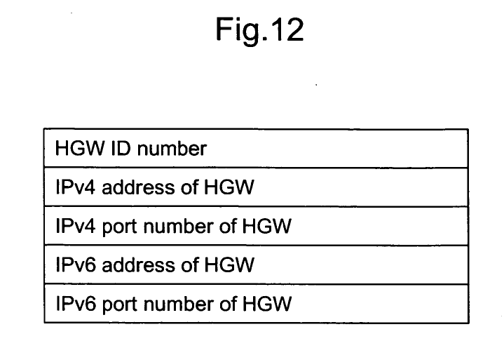

FIG. 12 shows an example of the server registration packet transmitted by HGW 100 according to the second embodiment. This server registration packet is different from the server registration packet shown in FIG. 4; it does not include camera information, but only includes a HGW ID number, an IPv4 address, an IPv4 port number, an IPv6 address and an IPv6 port number.

Based on the server registration packet received from DDNS packet registration unit 1102, DDNS server 106 stores HGW information in a server DB (not shown in the figures). Specifically, DDNS server 106 deletes an HGW ID number from the data contained in the server registration packet, assigns a host name for HGW 100, and stores the resulting HGW information on the server DB.

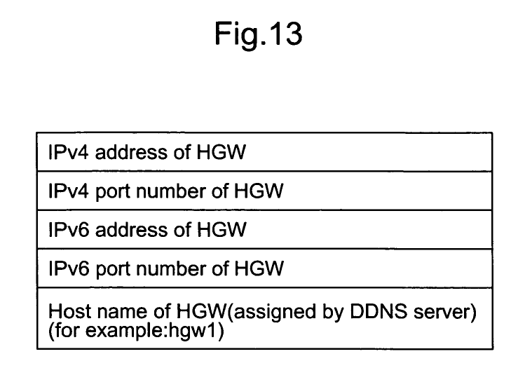

FIG. 13 shows an example of the HGW information stored in the server DB of DDNS server 106 according to the second embodiment. As FIG. 13 shows, the HGW information stored in the server DB is different from the information contained in the server registration packet shown in FIG. 12 in that the HGW ID number is deleted and a host name for HGW 100 (“hgw1” in FIG. 13) is added. Other data are the same as those contained in the server registration packet shown in FIG. 12.

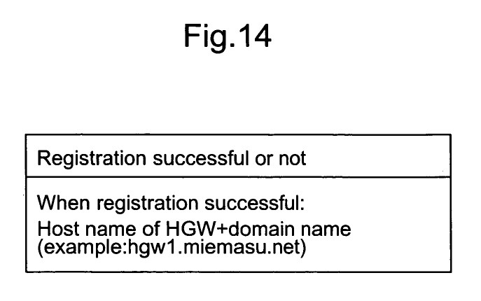

Upon receiving the server registration packet from DDNS packet registration unit 1102 and storing the HGW information in the server DB, DDNS server 106 transmits to HGW 100 a response packet indicating that the registration was successful. FIG. 14 shows an example of the response packet transmitted by DDNS server 106 according to the second embodiment. As FIG. 14 shows, a response packet contains whether a registration was successful. When the registration was successful, the response packet further contains a domain name (for example, hgw1.miemasu.net), which is a combination of the host name of HGW 100 and the domain name managed by DDNS server 106.

The following describes the operations that are performed until the image data of the first camera 102 in the home is checked from PC 105 in the monitoring system, to which HGW 100 according to the second embodiment is applied.

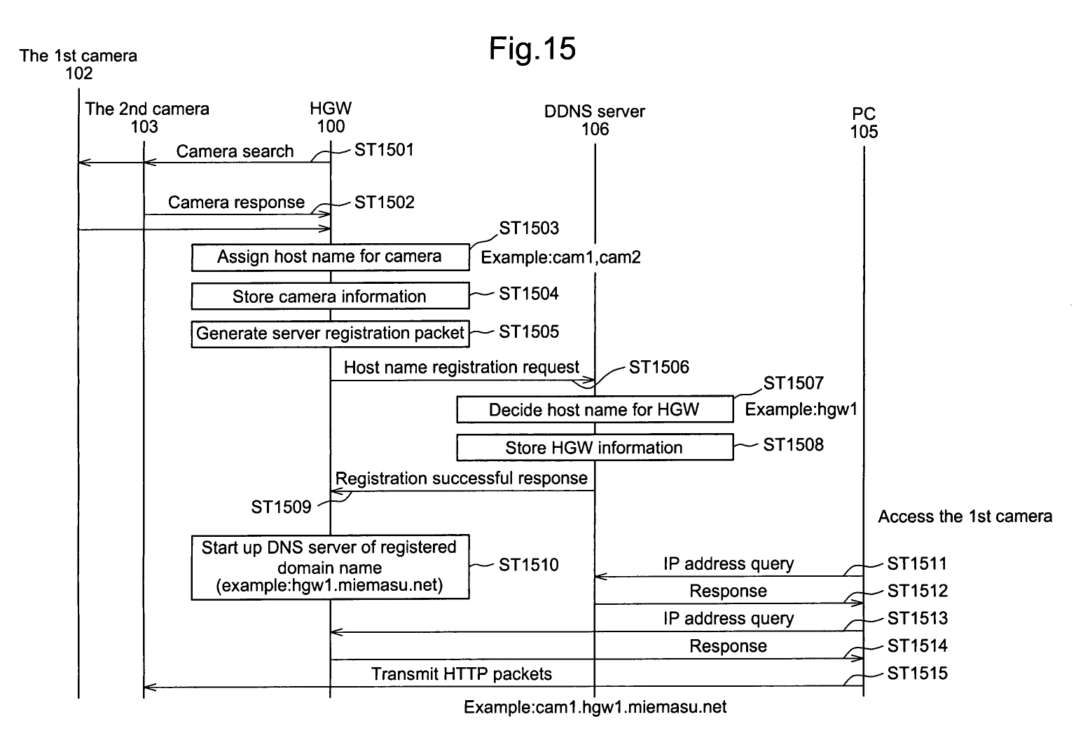

FIG. 15 shows a sequence diagram describing operations performed until image data of the first camera 102 in the home are checked from PC 105 in the monitoring system, to which HGW 100 according to the second embodiment is applied. FIG. 15 shows the case where the first camera 102 and the second camera 103 are installed in the home. The first camera 102 and the second camera 103 are each assigned an IPv6 address and an IPv6 port number when connected to a network. FIG. 15 further shows the case where a camera search is performed by camera search unit 203 of HGW 100.

By booting up HGW 100 installed in the home, the sequence of operations shown in FIG. 15 is started. When booted up, HGW 100 performs a search (camera search) for cameras (the first camera 102 and the second camera 103) installed in the home (ST 1501). When camera search is performed, HGW 100 receives a response (camera response), which contains a camera ID number, an IPv6 address and the like, from each of the cameras connected to the network (ST 1502).

Upon receiving camera responses from all cameras, HGW 100 assigns a host name for each of the cameras (ST 1503). When assigning a host name, HGW 100 assigns as necessary an IPv4 address and the like as well for each of the cameras. Then, HGW 100 stores in camera information DB 202 the information including host names and the like as camera information (ST 1504). For example, as camera information for the first camera 102, the camera information shown in FIG. 3 is stored in camera information DB 202. As FIG. 3 shows, “cam1” is stored as the host name for the first camera 102.

After camera information for all cameras are stored in camera information DB 202, HGW 100 generates a server registration packet as shown in FIG. 12 (ST 1505).

Upon generating the server registration packet, HGW 100 transmits the generated server registration packet to DDNS server 106, and requests the registration of a host name for HGW 100 (ST 1506).

Upon receiving the request for the registration of a host name, DDNS server 106 assigns a host name to HGW 100 (ST 1507). Then, DDNS server 106 stores in the server DB as the HGW information the host name, IP address and the like for HGW 100 (ST 1508). For example, the HGW information shown in FIG. 13 is stored in the server DB as the HGW information for HGW 100. As FIG. 13 shows, “hgw1” is stored as the host name for HGW 100.

After the HGW information is stored in the server DB, DDNS server 106 transmits to HGW 100 a response packet, shown in FIG. 14, indicating the registration was successful (ST 1509). By receiving the response packet, HGW 100 becomes aware of that the HGW information including the host name for HGW 100 has been stored in the server DB of DDNS server 106.

Upon receiving the response packet indicating that the registration was successful, HGW 100 starts up DNS server 1101 of a domain name (for example, hgw1.miemasu.net) containing the host name of HGW 100 and the domain name managed by DDNS server 106 (ST 1510).

Here, in order to check the image data of the first camera 102, a user of PC 105 uses a browser function to access the first camera 102. When doing so, the user of PC 105 accesses the first camera 102 by specifying the host name (cam1) of the first camera 102 and the host name (hgw1) of HGW 100. Specifically, the user of PC 105 specifies “http://cam1.hgw1.miemasu.net/” in the browser.

When the user specifies “http://cam1.hgw1.miemasu.net/” in the browser, PC 105 transmits to DDNS server 106 a query regarding the IPv6 address of HGW 100 (ST 1511). In response to the query, DDNS server 106 transmits to PC 105 the IPv6 address of HGW 100 (ST 1512). PC 105 next transmits to HGW 100 a query regarding the IPv6 address of the first camera 102 (ST 1513). In response to the query, HGW 100 transmits to PC 105 the IPv6 address of the first camera 102 (ST 1514).

Upon receiving the IPv6 address of the first camera 102, PC 105 transmits to the IPv6 address a packet according to the HTTP protocol (ST 1515). Thereafter, it becomes possible to check the image data of the first camera 102 on a display or the like of PC 105.

The following describes the operations performed by HGW 100 and DDNS server 106 according to the second embodiment.

In the second embodiment, same as in the first embodiment, camera information for the cameras controlled by HGW 100 is automatically or manually stored in camera information DB 202 by performing the steps shown in FIG. 7 and FIG. 8.

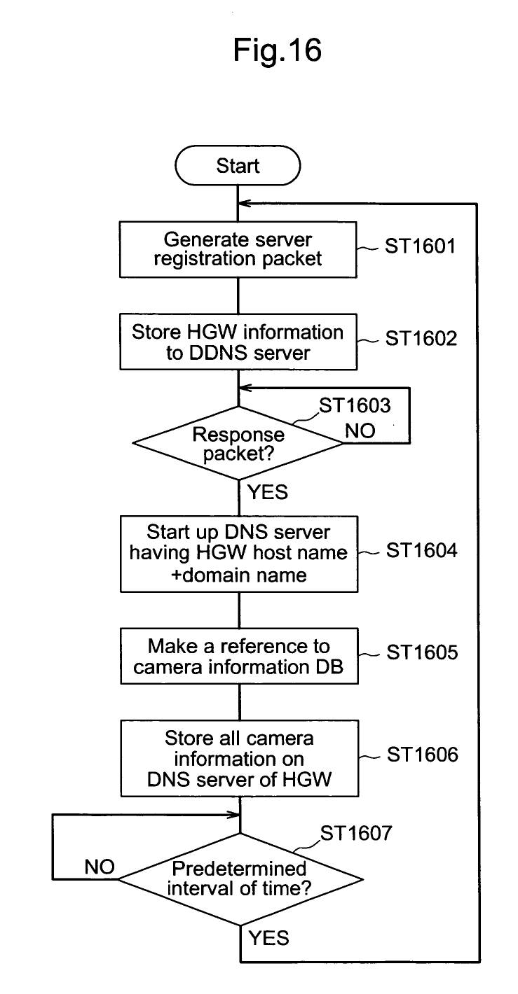

FIG. 16 is a flow chart describing an operation (the server registration operation) of registering HGW information on DDNS server 106, of HGW 100 according to the second embodiment.

While in operation, HGW 100 repeats the server registration operation shown in FIG. 16 every predetermined interval of time (30 seconds, for example).

When executing the server registration operation, HGW 100 first generates a server registration packet shown in FIG. 12 (ST 1601). The server registration packet includes the ID number, IP addressees and the like of HGW 100. The generated server registration packet is then transmitted to DDNS server 106 and stored in the server DB as HGW information shown in FIG. 13 (ST 1602). After the server registration packet is transmitted to DDNS server 106, HGW 100 determines whether a response packet as shown in FIG. 14 has been received until the response packet is received (ST 1603).

Upon receiving the response packet, HGW 100 starts up DNS server 1101 of the domain name (for example, hgw1.miemasu.net) containing the host name of HGW 100 and the domain name managed by DDNS server 106 (ST 1604). Further, HGW 100 makes a reference to the camera information stored in camera information DB 202 (ST 1605), and stores all camera information on DNS server 1101 of HGW 100 (ST 1606).

Upon storing all camera information, HGW 100 monitors whether a predetermined interval of time has passed (ST 1607). When it is confirmed that the predetermined interval of time has passed, HGW 100 returns to ST 1601 and performs again the server registration operation. As described above, information about HGW 100 is stored on the DDNS server, and information about the cameras controlled by HGW 100 is stored on the DNS server of HGW 100.

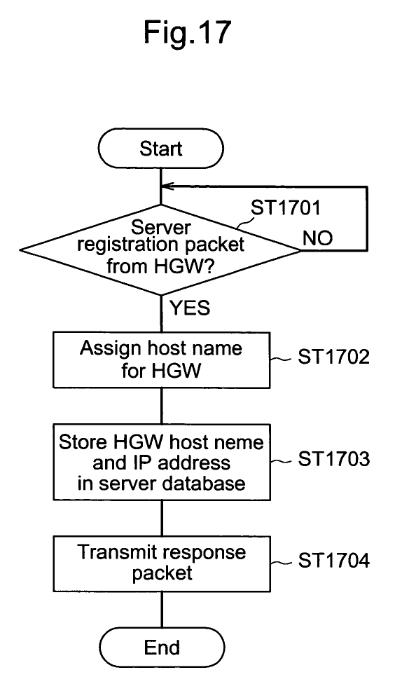

FIG. 17 is a flow chart describing the operation (the HGW information registration operation) of registering HGW information, on DDNS server 106 according to the second embodiment.

When executing the HGW information registration operation, DDNS server 106 monitors the reception of a server registration packet from HGW 100 until the server registration packet is received (ST 1701). Upon receiving the server registration packet, DDNS server 106 assigns a host name to HGW 100 (ST 1702). In assigning the host name to HGW 100, DDNS server 106 refers to the server DB so as to avoid duplicating host names. Then, DDNS server 106 stores the host name and the IP addresses of HGW and the like contained in the server registration packet in the server DB as HGW information (ST 1703).

After storing the host name and the like of HGW 100, DDNS server 106 transmits to HGW 100 a response packet indicating that the registration was successful (ST 1704).

Although the first and the second embodiments are explained using cameras 102, 103 and 104, the present invention is not limited to these devices. The present invention is also applicable to terminal apparatuses such as televisions, personal computers, video cassette recorders, refrigerators, air conditioners, washing machines, IP telephones, and the like, as far as they are Internet-capable.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2005-298719 filed on Oct. 13, 2005, entire content of which is expressly incorporated by reference herein.

What is claimed is:

1. A gateway apparatus connected to a terminal apparatus and a DNS server via a network, the gateway apparatus comprising:
an address obtainer that obtains, from the terminal apparatus via the network, an IPv6 address assigned to the terminal apparatus;
a host name assigner that assigns a host name to the terminal apparatus;
a memory that stores the host name of the terminal apparatus and the IPv6 address of the terminal apparatus; and
a registration controller that stores, in the DNS server via the network, the host name of the terminal apparatus and the IPv6 address of the terminal apparatus, in association with a host name of the gateway apparatus, the host name of the gateway apparatus being assigned to the gateway apparatus by the DNS server.

2. The gateway apparatus according to claim 1 further being connected to an apparatus via the network and comprising a receiver that receives the host name of the terminal apparatus and the IPv6 address of the terminal apparatus, the host name of the terminal apparatus and the IPv6 address of the terminal apparatus being input from the apparatus via the network.

3. The gateway apparatus according to claim 1, wherein the host name assigner assigns, in addition to the host name, an IPv4 address to the terminal apparatus.

4. The gateway apparatus according to claim 1, wherein
the memory stores a plurality of host names and IPv6 addresses, each of the plurality of the host names and the IPv6 addresses being assigned to each of a plurality of terminal apparatuses; and
the registration controller stores, in the DNS server via the network, the plurality of the host names and the IPv6 addresses, in association with the host name assigned to the gateway apparatus.

5. The gateway apparatus according to claim 1, wherein the terminal apparatus is a camera.

6. A gateway apparatus connected to a terminal apparatus and a DNS server via a network, the gateway apparatus comprising:
an address obtainer that obtains, from the terminal apparatus via the network, an IPv6 address assigned to the terminal apparatus;
a host name assigner that assigns a host name to the terminal apparatus;
a memory that stores the host name of the terminal apparatus and the IPv6 address of the terminal apparatus;
a registration controller that stores, in the DNS server via the network, an IPv6 address assigned to the gateway apparatus, in association with a host name of the gateway apparatus, the host name of the gateway apparatus being assigned to the gateway apparatus by the DNS server; and
a name resolver that transmits, when the gateway apparatus receives a query, using the host name of the terminal apparatus, for the IPv6 address of the terminal apparatus, the IPv6 address of the terminal apparatus stored in the memory.

7. The gateway apparatus according to claim 6 further being connected to an apparatus via the network and comprising a receiver that receives the host name of the terminal apparatus and the IPv6 address of the terminal apparatus, the host name of the terminal apparatus and the IPv6 address of the terminal apparatus being input from the apparatus via the network.

8. The gateway apparatus according to claim 6, wherein the host name assigner assigns, in addition to the host name, an IPv4 address to the terminal apparatus.

9. The gateway apparatus according to claim 6, wherein the terminal apparatus is a camera.

10. A server apparatus connected to a gateway apparatus via a network, the gateway apparatus being connected to a terminal apparatus via the network, the gateway apparatus obtaining, from the terminal apparatus, an IPv6 address assigned to the terminal apparatus and assigning a host name to the terminal apparatus, the server apparatus comprising:
a receiver that receives, from the gateway apparatus via the network, the host name of the terminal apparatus and the IPv6 address of the terminal apparatus;
a host name assigner that assigns, to the gateway apparatus, a host name of the gateway apparatus; and
a memory that stores the host name of the terminal apparatus and the IPv6 address of the terminal apparatus, in association with the host name of the gateway apparatus.

11. A server apparatus connected to a gateway apparatus via a network, the gateway apparatus being connected to a terminal apparatus via the network, the gateway apparatus obtaining, from the terminal apparatus, an IPv6 address assigned to the terminal apparatus and assigning a host name to the terminal apparatus, the server apparatus comprising:
a receiver that receives, from the gateway apparatus via the network, an IPv6 address assigned to the gateway apparatus;
a host name assigner that assigns, to the gateway apparatus, a host name of the gateway apparatus;
a memory that stores the IPv6 address of the gateway apparatus, in association with the host name of the gateway apparatus; and
a name resolver that transmits, when the server apparatus receives a query, using the host name of the terminal apparatus, for the IPv6 address of the terminal apparatus, the IPv6 address of the gateway apparatus stored in the memory.

12. A method for managing an IP address of a terminal apparatus, the terminal apparatus being connected to a gateway apparatus, the gateway apparatus being connected to a DNS server via a network, the method comprising:
obtaining, from the terminal apparatus, an IPv6 address assigned to the terminal apparatus;
assigning, at the gateway apparatus, a host name to the terminal apparatus;
storing, at the gateway apparatus, the host name of the terminal apparatus and the IPv6 address of the terminal apparatus; and
registering, from the gateway apparatus to the DNS server via the network, the host name of the terminal apparatus and the IPv6 address of the terminal apparatus, in association with a host name of the gateway apparatus, the host name of the gateway apparatus being assigned to the gateway apparatus by the DNS server.

13. A method for managing an IP address of a terminal apparatus, the terminal apparatus being connected to a gateway apparatus, the gateway apparatus obtaining, from the terminal apparatus, an IPv6 address assigned to the terminal apparatus and assigning a host name to the terminal apparatus, the gateway apparatus being connected to a DNS server via a network, the method comprising
receiving, at the DNS server from the gateway apparatus via the network, the host name of the terminal apparatus and the IPv6 address of the terminal apparatus;
assigning, at the DNS server to the gateway apparatus, a host name of the gateway apparatus; and
storing, at the DNS server, the host name of the terminal apparatus and the IPv6 address of the terminal apparatus, in association with the host name of the gateway apparatus.

14. A method for managing an IP address of a terminal apparatus, the terminal apparatus being connected to a gateway apparatus, the gateway apparatus being connected to a DNS server via a network, the method comprising:
obtaining, from the terminal apparatus, an IPv6 address assigned to the terminal apparatus;
assigning, at the gateway apparatus, a host name to the terminal apparatus;
storing, at the gateway apparatus, the host name of the terminal apparatus and the IPv6 address of the terminal apparatus;
registering, from the gateway apparatus to the DNS server via the network, an IPv6 address assigned to the gateway apparatus, in association with a host name of the gateway apparatus, the host name of the gateway apparatus being assigned to the gateway apparatus by the DNS server; and
transmitting, when the gateway apparatus receives a query, using the host name of the terminal apparatus, for the IPv6 address of the terminal apparatus, the IPv6 address of the terminal apparatus stored at the gateway apparatus.

15. A method for managing an IP address of a terminal apparatus, the terminal apparatus being connected to a gateway apparatus, the gateway apparatus obtaining, from the terminal apparatus, an IPv6 address assigned to the terminal apparatus and assigning a host name to the terminal apparatus, the gateway apparatus being connected to a DNS server via a network, the method comprising
receiving, at the DNS server from the gateway apparatus via the network, an IPv6 address assigned to the gateway apparatus;
assigning, at the DNS server to the gateway apparatus, a host name of the gateway apparatus; and
storing, at the DNS server, the IPv6 address of the gateway apparatus, in association with the host name of the gateway apparatus; and
transmitting, when the DNS server receives a query, using the host name of the terminal apparatus, for the IPv6 address of the terminal apparatus, the IPv6 address of the gateway apparatus stored at the DNS server.
